(19) United States
(12) Patent Application Publication
(10) Pub. No.: US 2015/0367670 A1
(43) Pub. Date: Dec. 24, 2015

(54) METHOD OF USING LASER ABLATION TO REVEAL UNDERLYING SECURITY FEATURE AND DEVICE OBTAINED THEREBY

(71) Applicant: ASSA ABLOY AB, Stockholm (SE)

(72) Inventors: Christopher J. DYBALL, Half Moon Bay, CA (US); John M BOVE, San Carlos, CA (US); Robert SMITH, Scotts Valley, CA (US)

(73) Assignee: ASSA ABLOY AB, Stockholm (SE)

(21) Appl. No.: 14/765,354

(22) PCT Filed: Mar. 7, 2013
(86) PCT No.: PCT/US13/29676

§ 371 Date: Aug. 3, 2015

(51) Int. Cl. B42D 25/36; B42D 25/328; B41J 2/435

(52) U.S. Cl. CPC B42D 25/36; B41J 2/435; B42D 25/328

(57) ABSTRACT

A credential with one or more security features is disclosed. The disclosed credential includes a thin-film metal layer that can be utilized as a recording media. The thin-film metal layer may also have portions thereof removed to reveal at least one underlying layer, such as a photoreactive layer. A method of manufacturing such a credential is also disclosed.

### FIELD OF THE DISCLOSURE

The present disclosure is generally directed toward security features and methods of incorporating security features into documents, credentials, passports, and other substrates.

### BACKGROUND

The use of identification documents and other credentials is pervasive. Credentials are used on a daily basis for a number of different purposes. Credentials are most commonly used to prove identity, to verify age, to access an asset (e.g., secure area, financial account, computing resource, etc.), to evidence driving privileges, to cash a check, and so on. Airplane passengers are required to show a credential during check in, and sometimes at security screening and prior to boarding their flight. We also live in an ever-evolving cashless society where credentials are used to make payments, access an automated teller machine (ATM), debit an account, or make a payment, etc. Many industries require that their employees carry photo identification credentials on the job and to access various locations on a job site.

While many different types of security features have been developed to enhance the security associated with credentials, few have been as useful and difficult to copy as holographic features. Holographic features are most often a photograph or image of an interference pattern that, when suitably illuminated, produces a seemingly three-dimensional image. Holographic features, however, can also be images of text, numbers, or characters if desired. Lasers or incoherent light sources are often the primary tool used to manufacture holographic features.

Lasers can also be used to ablate, remove, or inscribe layers of material. Specifically, another type of security feature that can be produced with a laser is a laser-inscribed feature. Both laser-inscribed features and holographic features are particularly difficult to copy because specialized equipment is required to produce a copy and a specialized knowledge of the process used to manufacture the feature is also required.

### SUMMARY

It is, therefore, one aspect of the present disclosure to provide a credential with one or more security features. In particular, embodiments of the present disclosure provide a credential or document having a thin-film metal layer that can be utilized as a recording media. Even more specifically, embodiments of the present disclosure contemplate the providing a thin-film metal layer on or in a credential or document and then removing at least a portion of the thin-film metal layer to reveal at least one underlying layer, such as a photoreactive layer.

In some embodiments, a thin-film metal layer comprising tin (Sn), a tin alloy, other soft metals (e.g., any metal having a melting temperature less than or equal to 500 degrees Centigrade), or any other metal that is deposited on a credential or document. The thin-film metal layer may be deposited using any type of known deposition or application technique such as, for example, Chemical Vapor Deposition (CVD), Atomic Layer Deposition (ALD), plating, Chemical Solution Deposition (CSD), spin coating or spin casting, sputtering, cathodic arc deposition, any physical deposition technique, any chemical deposition technique, combinations thereof, or suitable alternatives. In some embodiments, the thin-film metal layer is provided over an underlying photoreactive layer and at least some portions of the thin-film metal layer can be removed to reveal at least some of the underlying photoreactive layer.

The thin-film metal layer, in some embodiments, may comprise a thickness between about 100 Å and about 1000 Å, or preferably between about 250 Å and 1000 Å, or even more preferably between about 300 Å and 600 Å. With such a thin-film metal layer (e.g., a thin-film metal layer of such a composition and thickness), the thin-film metal layer can be removed with a relatively low-power laser (e.g., a laser that delivers no more than 100 mW at the working surface). More specifically, a thin-film metal layer as disclosed herein can be ablated with a 780 nm low power diode laser that delivers approximately 30 mW at the working surface. One advantage to using such a laser is the relative low-cost required to obtain such a laser. Another advantage to using such a laser is that a small beam size can be used to ablate the thin-film metal layer. The smaller beam size (e.g., an elliptical beam of 2.3 μm×2.6 μm) can achieve a very high-resolution image (e.g., resolution of up to 10,000 dpi).

Although embodiments of the present disclosure enable the use of a low-power laser, it may also be possible to utilize a thin-film metal layer of a different construction and/or thickness that is ablated with a higher-power laser. For instance, a thin-film metal layer constructed of a higher melting-point metal such as Aluminum or any other metal of a higher thermal conductivity may be used. Also, a thin-film metal layer may be produced with a thickness greater than or equal to 1000 Å. When a thicker material or higher melting-point material is used, a 1064 nm YAG laser may be used to ablate portions of the metal layer. These higher-powered lasers can be configured to deliver approximately 5-30 W of power at the working surface and can usually achieve a resolution between 300 dpi and 600 dpi. It should be appreciated that there may be some advantages to using this higher-power laser. For instance, the use of a higher-power and higher-cost laser may make the copying of security features produced thereby more cost prohibitive.

In some embodiments, a method of producing a document or credential having at least one security feature is also described. More specifically, the method may include providing a security element over a substrate, the security element comprising a thin-film metal layer and then removing at least some portions of the thin-film metal layer to reveal an underlying photoreactive layer, the underlying photoreactive layer being established in at least one of the security element and the substrate.

In some embodiments, the underlying photoreactive layer may correspond to one or several materials that are reactive to visible, infrared (IR), and/or ultraviolet (UV) light. As can be appreciated, the photoreactive layer underlying the thin-film metal layer may comprise material or pigments that are visible under white or visible light. The underlying photoreactive layer may alternatively or additionally comprise light-reactive materials such as UV and/or IR dyes or pigments. Alternatively or additionally, the photoreactive layer may comprise optically variable ink. In still other embodiments, the revealed features of the underlying photoreactive layer may correspond to one or more of microlines, microtext guilloche, rainbow prints, and so on.

In some embodiments, the thin-film metal layer may be ablated to produce an image in concert with the underlying photoreactive layer. Laser recording of an image in the thin-film metal layer may occur by local ablation and, if overlying layers of the media are transparent, the recorded areas (e.g., areas where ablation occurs) become transparent rendering any features underlying the media visible or photoreactive. The revealing of underlying security printing may be valuable in that it ties the laser recorded image and the substrate together rendering attempts at fraudulent manipulation of the document or credential much more difficult. Furthermore, since ablating areas of the thin-film metal layer create the image(s), it becomes difficult if not impossible to add additional features to the image in those areas where the thin-film metal layer has been ablated and match the image characteristics. For instance, one could not add a beard to an already recorded image as the material of the thin-film metal layer has already been ablated in that area.

The manufacturing techniques described herein are much different from the conventional process of laser engraving images on plastic cards where a high power laser is used to carbonize areas in the card creating a grayscale image; mostly because these types of images can have additional features added thereto relatively easily.

For the purposes of this disclosure, credentials and/or documents are broadly defined and may include, for example, credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments or documentation, security clearance badges and cards, gun permits, hunting or fishing permits, gift certificates or cards, labels or product packaging, membership cards or badges, security paper, card stock, etc. Also, the terms “document,” “credential,” “card,” and “documentation” are used interchangeably throughout. Credentials are also sometimes interchangeably referred to as “security documents,” “ID documents,” “identification documents,” “security credentials,” “photo-IDs,” and “photo ID documents”.

Further still, security features of the present disclosure can be applied to any type of material (e.g., paper, plastic, combinations thereof, etc.). It should be appreciated that the embodiments disclosed herein can be applied to passport pages (e.g., paper and plastic), RFID cards (e.g., plastic cards), and pure paper documents. It is also possible to produce one or more patches of material that can be applied to a paper or plastic document. The production of a security feature on such a patch may occur before or after the patch is applied to the document—that is ablation of the thin-film metal layer may occur before or after patch application.

The present invention will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1A is a first cross-sectional view of a first document or credential without ablation in accordance with embodiments of the present disclosure;

FIG. 1B is a second cross-sectional view of the first document or credential with ablation in accordance with embodiments of the present disclosure;

FIG. 2A is a first cross-sectional view of a second document or credential without ablation in accordance with embodiments of the present disclosure;

FIG. 2B is a second cross-sectional view of the second document or credential with ablation in accordance with embodiments of the present disclosure;

FIG. 3A is a first cross-sectional view of a third document or credential without ablation in accordance with embodiments of the present disclosure;

FIG. 3B is a second cross-sectional view of the third document or credential with ablation in accordance with embodiments of the present disclosure;

FIG. 4A is a first cross-sectional view of a fourth document or credential without ablation in accordance with embodiments of the present disclosure;

FIG. 4B is a second cross-sectional view of the fourth document or credential with ablation in accordance with embodiments of the present disclosure;

FIG. 5A is a first cross-sectional view of a fifth document or credential without ablation in accordance with embodiments of the present disclosure;

FIG. 5B is a second cross-sectional view of the fifth document or credential with ablation in accordance with embodiments of the present disclosure;

FIG. 6A is a first cross-sectional view of a sixth document or credential without ablation in accordance with embodiments of the present disclosure;

FIG. 6B is a second cross-sectional view of the sixth document or credential with ablation in accordance with embodiments of the present disclosure;

FIG. 7A is a first cross-sectional view of a seventh document or credential without ablation in accordance with embodiments of the present disclosure;

FIG. 7B is a second cross-sectional view of the seventh document or credential with ablation in accordance with embodiments of the present disclosure;

FIG. 8A is a first cross-sectional view of an eighth document or credential without ablation in accordance with embodiments of the present disclosure;

FIG. 8B is a second cross-sectional view of the eighth document or credential with ablation in accordance with embodiments of the present disclosure;

FIG. 9A is a first cross-sectional view of a ninth document or credential without ablation in accordance with embodiments of the present disclosure;

FIG. 9B is a second cross-sectional view of the ninth document or credential with ablation in accordance with embodiments of the present disclosure;

FIG. 10A is a first cross-sectional view of a tenth document or credential without ablation in accordance with embodiments of the present disclosure;

FIG. 10B is a second cross-sectional view of the tenth document or credential with ablation in accordance with embodiments of the present disclosure;

FIG. 11A is a first cross-sectional view of an eleventh document or credential without ablation in accordance with embodiments of the present disclosure;

FIG. 11B is a second cross-sectional view of the eleventh document or credential with ablation in accordance with embodiments of the present disclosure; and

FIG. 12 is a flow diagram depicting a method of manufacturing a document or credential in accordance with embodiments of the present disclosure.

### DETAILED DESCRIPTION

The ensuing description provides embodiments only, and is not intended to limit the scope, applicability or configuration of the claims. Rather, the ensuing description will provide those skilled in the art with an enabling description for implementing the described embodiments. It being understood that various changes may be made in the function and arrangement of elements without departing from the spirit and scope of the appended claims.

It should also be appreciated that the figures provided herein are not necessarily drawn to scale. In particular, certain elements, such as a thin-film metal layer, adhesive, or the like, have depicted dimensions that are not necessarily representative of actual dimensions. The actual and/or relative dimensions of the elements described herein should not be interpreted or limited based on the dimensions of those elements shown in the figures. Rather, the figures have elements depicted as having a certain dimension or thickness primarily for ease of discussion and for ease of understanding where one element resides relative to another element.

Additionally, security features will be described herein with respect to various types of credentials or documents. It should be appreciated that certain aspects from one example may be used or applied to other examples and vice versa. As a non-limiting example, features described in connection with one figure may be used wholly or partially in a credential or document described in connection with another different figure. Further still, different security features of different types may be incorporated into a single credential or document or a single security patch that can be applied to a credential or document.

The following description will provide various embodiments or characteristics of a credential or document comprising a security feature or security element, where the security feature or security element includes a thin-film metal layer and where at least a portion of the thin-film metal layer has been removed to reveal an underlying photoreactive layer. The underlying photoreactive layer may be established in the security feature or element simultaneous with the thin-film metal layer (e.g., as a patch) and/or it may be established in or on a substrate of the credential or document.

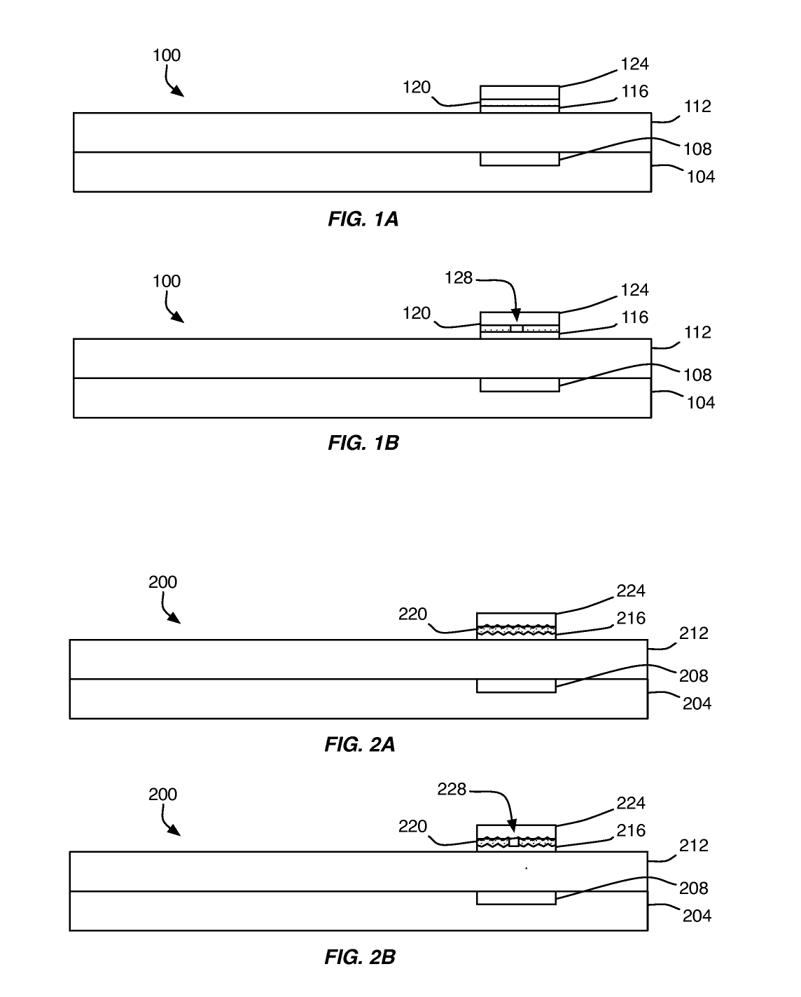

FIGS. 1A and 1B depict a first example of a credential or document 100 (referred to as a “credential” for ease of discussion) in accordance with embodiments of the present disclosure. The depicted credential 100 depicts an embodiment whereby the credential 100 comprises a hot stamp or label applied to a laminate containing an underlying photoreactive layer.

Even more specifically, the credential 100 comprises a substrate 104 with a photoreactive layer 108 established therein or thereon. The substrate 104 comprises a first major surface (e.g., an upper surface) and an opposing second major surface (e.g., a lower surface). The first major surface of the substrate 104 may have the photoreactive layer 108 located proximate thereto. In some embodiments, the substrate 104 may have the photoreactive layer 108 printed on its first major surface. In some embodiments, the substrate 104 may have the photoreactive layer 108 established in a cavity or recess that resides on the first major surface. The substrate 104 may be constructed of or comprise plastic, paper, a combination of plastic and paper, any other known composite, a woven material, wood, metal, or combinations thereof. The substrate 104 may comprise any type of material or combination of materials known in the production of credentials or supports thereof.

The photoreactive layer 108 may include any type of material or combinations of materials that are reactive (partially or completely) to illumination. For instance, the photoreactive layer 108 may comprise materials or pigments that are visible or reactive to light in the visible spectrum. Alternatively or additionally, the photoreactive layer 108 may include UV and/or IR dyes or pigments. Alternatively or additionally, the photoreactive layer 108 may include optically variable ink. Alternatively or additionally, the photoreactive layer 108 may comprise phosphor or the like.

The credential 100 further includes a transparent layer 112 overlying the photoreactive layer 108 and substrate 104. More specifically, the transparent layer 112 may comprise a first major surface (e.g., an upper surface) and an opposing second major surface (e.g., a lower surface). In some embodiments, the second major surface of the transparent layer 112 abuts or is located proximate to the first major surface of the substrate 104 and the photoreactive layer 108.

In some embodiments, the transparent layer 112 is constructed of a polymer or plastic that is transparent or translucent. Suitable materials that may be used for the transparent layer 112 include, without limitation, polyethylene, polypropylene, polystyrene, polyvinyl chloride (PVC), polycarbonate (PC), polyurethane (PU), polyvinylidene chloride (PVDC), polyethylene terephthalate (PET), and polytetrafluoroethylene (PTFE).

The transparent layer 112 may be established proximate the first major surface of the substrate 104 after the photoreactive layer 108 is provided on the first major surface. The transparent layer 112 may be temporarily or permanently fixed in its position relative to the substrate 104. As an example, the transparent layer 112 may correspond to a laminate that is substantially fixed or secured to the substrate 104 via the application of heat and/or pressure.

The credential 100 further comprises a security element established on or proximate to the first major surface of the transparent layer 112. In some embodiments, the security element comprises a plurality of layers including an adhesive layer 116, a thin-film metal layer 120, and a protective layer 124. As can be appreciated, the total thickness of the security element may not be as large as depicted. In most circumstances, the total thickness of the security element is only a fraction of the thickness of the substrate 104; however, the enlarged security element and its layers are shown for clarity.

In some embodiments, the security element may correspond to a hot stamp, label, or patch that can be applied to the transparent layer 112 of the credential 100. The security element may be positioned proximate to the transparent layer 112 and affixed thereto with the adhesive 112 either before, during, or after the transparent layer 112 is positioned relative to the substrate 104. As an example, the security element may be secured to the transparent layer 112 in the same step where the transparent layer 112 is laminated to the substrate 104. As another example, the transparent layer 112 may first be laminated to the substrate 104 and then the security element may be positioned proximate to the first major surface of the transparent layer 112.

In some embodiments, the security element is positioned so that it at least partially covers the photoreactive layer 108. Even more specifically, the security element may be positioned relative to the substrate 104 such that the photoreactive layer 108 is partially or completely covered by the thin-film metal layer 120.

The security element may be manufactured with any variety of techniques. As one non-limiting example, the security element may be manufactured as a hot-stamp or label separate from the substrate 104 and transparent layer 112. The protective layer 124 may be provided as a substrate during production of the security element and then the thin-film metal layer 120 may be deposited on the protective layer 124. In some embodiments, the protective layer 124 corresponds to a transparent or translucent plastic or composite material and the thin-film metal layer 120 is deposited on the protective layer 124 using a thin-film deposition process. Examples of such processes that may be used to deposit the thin-film metal layer 120 on the protective layer 124 include CVD, ALD, plating, CSD, spin coating or spin casting, sputtering, cathodic arc deposition, any physical deposition technique, any chemical deposition technique, or combinations thereof.

In some embodiments, the thin-film metal layer 120 is deposited on the protective layer 124 such that it has a thickness of no more than 1000 Å. As can be appreciated, the thickness of the thin-film metal layer 120 may depend upon the deposition process used to deposit the thin-film metal layer. Moreover, the material composition of the thin-film metal layer 120 may impact the thickness thereof. As one example, the thin-film metal layer 120 comprises tin or a similar type of low melting-point metal that can be ablated with a low-power laser.

To complete construction of the security element, the adhesive layer 116 may be provided on the thin-film metal layer 120. The adhesive layer 116 may correspond to a transparent or translucent material that can physically or chemically adhere the other layers of the security element to the transparent layer 112. The adhesive layer 116 may comprise any type of liquid, semi-liquid, or solid adhesive or combinations of adhesives. The adhesive layer 116 may comprise a drying adhesive, a pressure-sensitive adhesive, a contact adhesive, a hot adhesive, a multi-part reactive adhesive, a one-part reactive adhesive, bonding tape, or combinations thereof. The adhesive layer 116 may be applied to the transparent layer 112 and then the other portions of the security element may be attached to the transparent layer 112 via the adhesive layer 116. Alternatively, the adhesive layer 116 may be initially provided on the thin-film metal layer 120 and then the security element may be adhered to the transparent layer 112.

The example of FIG. 1A shows a security element without any ablation or removal of the thin-film metal layer 120. When none of the thin-film metal layer 120 is removed, the photoreactive layer 108 is not visible (at least where it is covered by the thin-film metal layer 120). FIG. 1B, on the other hand, shows the security element as having at least some of the thin-film metal layer 120 ablated or removed. Depending upon the nature of the thin-film metal layer 120, the ablated portion 128 may be created by focusing a laser beam or incoherent light source substantially on the plane of the thin-film metal layer 120. In some embodiments, the ablated portion 128 may be created with a low-power laser.

It should be appreciated that the thin-film metal layer 120 may be ablated from the security element after application to a document or during production of the security element, the thin-film metal layer 120 may be removed or ablated after it has been provided on the protective layer 124 and prior to the adhesive 116 being applied thereto. In another example, the thin-film metal layer 120 may be ablated even with the protective layer 124 in place. If a laser beam is focused at the thin-film metal layer 120 and not the protective layer 124 it is possible to ablate at least some portions of the thin-film metal layer 120 without ablating, damaging, or removing any of the protective layer 124. In other words, the thin-film metal layer 120 may be ablated in-situ, either when the security element is created or after the security element has been placed on the transparent layer 112.

When the ablated portion 128 is created in the thin-film metal layer 124, at least a portion of the underlying photoreactive layer 108 becomes visible from the top of the credential 100. In some embodiments, the ablated portion 128 may be constructed to form an image or the like in combination with the underlying photoreactive layer 108. Thus, as the thin-film metal layer 120 is ablated, an image can be created that is substantially tied to the credential 100, its substrate 104, and the photoreactive layer 108 provided on the substrate 104. This helps increase the security of the credential 100 by making it harder to alter the image, especially by adding new features on top of the thin-film metal layer 120.

With reference now to FIGS. 2A and 2B, another example of a credential 200 will be described in accordance with embodiments of the present disclosure. In this example, the credential 200 comprises a hot stamp or label applied to a laminated containing an underlying photoreactive layer, where the hot stamp or label includes one or more holographic features.

More specifically, the credential 200 may be similar to credential 100 in that credential 200 comprises a substrate 204, a photoreactive layer 208, a transparent layer 212, and an overlying security element in the form of a hot stamp or label. It should be appreciated that the substrate 204, photoreactive layer 208, and transparent layer 212 may be similar or identical to the previously-discussed substrate, photoreactive layer, and transparent layer, respectively.

The security element of the credential 200 also comprises an adhesive layer 216, a thin-film metal layer 220, and a protective layer 224. The thin-film metal layer 220 and adhesive layer 216 may be similar or identical to the previously-discussed thin-film metal layer and adhesive layer, respectively. The protective layer 224 may be similar to the previously-discussed protective layer except that the protective layer 224 may be provided with one or more holographic features. In some embodiments, the holographic feature(s) may be created by one or more of an embossing process and a photopolymerization process. Any other known process for creating a holographic feature in a layer or multiple layers of material may also be utilized without departing from the scope of the present disclosure.

As shown in FIG. 2A, when the thin-film metal layer 220 is not removed or ablated, the photoreactive layer 208 is substantially covered. However, when at least a portion of the thin-film metal layer 220 is ablated, at least some of the photoreactive layer 208 is visible though the ablated portion 228. The ablation of the thin-film metal layer 220 may occur before or after the security element has been adhered to the transparent layer 212.

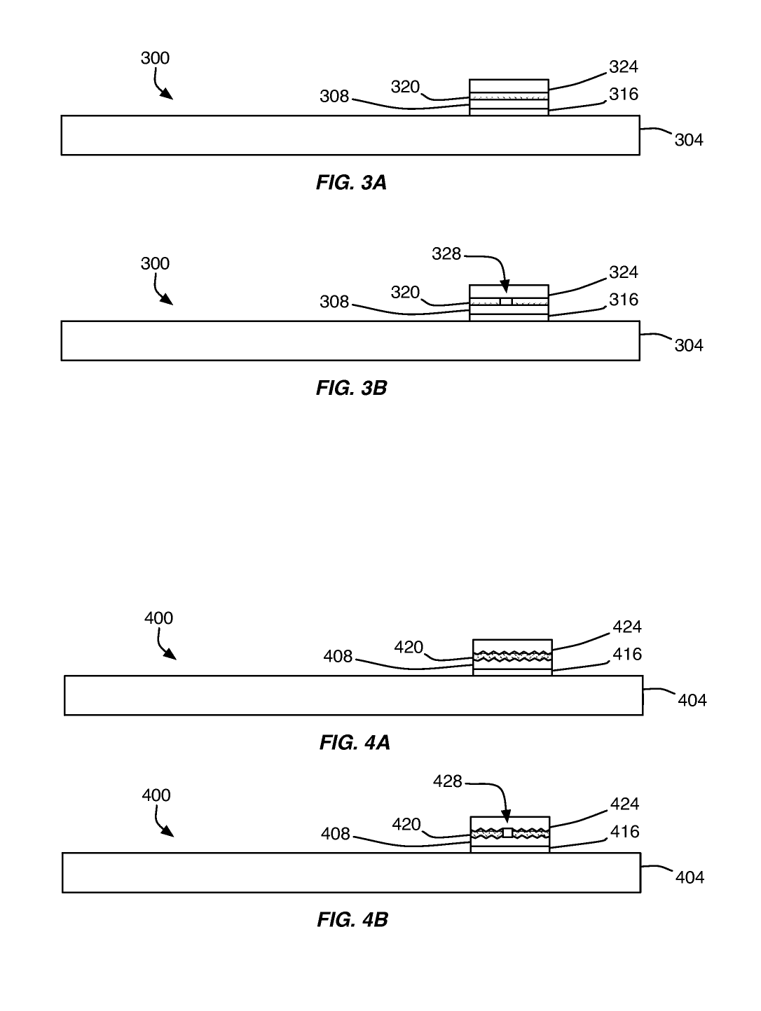

FIGS. 3A and 3B depict yet another example of a credential 300 in accordance with embodiments of the present disclosure. The credential 300 in this example comprises a hot stamp or label applied directly to a substrate of the credential 300. More specifically, the hot stamp or label is shown to include both the photoreactive layer and the thin-film metal layer.

In this example, the credential 300 includes a substrate 304 and the security element is attached directly to the substrate 304. Specifically, the substrate 304 comprises a first major surface and an opposing second major surface, the security element (e.g., in the form of a hot stamp or label) may be applied or adhered directly to one of the major surfaces of the substrate 304 (e.g., the first major surface). With the exception of not having the photoreactive layer incorporated therein, the substrate 304 may be similar or identical to any previously-discussed substrate.

In some embodiments, the security element comprises an adhesive layer 316, a photoreactive layer 308, a thin-film metal layer 320, and a protective layer 324, which may be similar or identical to any previously-discussed adhesive layer, photoreactive layer, thin-film metal layer, and protective layer, respectively. One difference, however, is that the photoreactive layer 308 is provided as part of the security element rather than as part of the substrate 304. Accordingly, the size of the photoreactive layer 308 may be different and the manner in which the photoreactive layer 308 is created may be different. For instance, the photoreactive layer 308 may be established on the thin-film metal layer 320 or the adhesive layer 316 during production of the security element before or after the security element is applied to the substrate 304. As another example, the thin-film metal layer 320 may be created on the protective layer 324 as discussed above or it may be deposited on the photoreactive layer 308 and then the protective layer 324 may be placed over the combination of the thin-film metal layer 320 and photoreactive layer 308.

FIG. 3A shows the thin-film metal layer 320 as not being ablated while FIG. 3B shows at least a portion of the thin-film metal layer 320 as being removed or ablated. In some embodiments, an ablated portion 328 of the thin-film metal layer 320 may reveal the underlying photoreactive layer 308. Creation of the ablated portion 328 may result in the production of an image due to the uncovering of the photoreactive layer 308. The ablated portion 328 may be created before or after the security element has been adhered to the substrate 304.

FIGS. 4A and 4B show yet another example of a credential 400 in accordance with embodiments of the present disclosure. The credential 400 of this example includes a combination of features from credential 200 and credential 300. Specifically, this credential 400 is shown to include a security element with an adhesive layer 416, a photoreactive layer 408, a thin-film metal layer 420, and a protective layer 424, similar to credential 300. However, the protective layer 424 includes at least one holographic feature similar to the security element of credential 200. The holographic feature(s) of the protective layer 424 may be created by one or more of an embossing process and a photopolymerization process. The thin-film metal layer 420 may then be applied to the protective layer 424 and at least partially conform to the holographic features incorporated therein.

Similar to credential 300, the security element of credential 400 may be adhered directly to substrate 404. The security element may be adhered to the substrate 404 during production of the security element or after the security element has been constructed. Moreover, at least some of the thin-film metal layer 420 may be ablated to reveal the underlying photoreactive layer 408. This ablated portion 428 may be created before or after the security element has been applied to the substrate 404. It should also be appreciated that depending upon the accuracy of the ablation process and when the ablation process occurs, some of the ablated portion 428 may extend into the photoreactive layer 408.

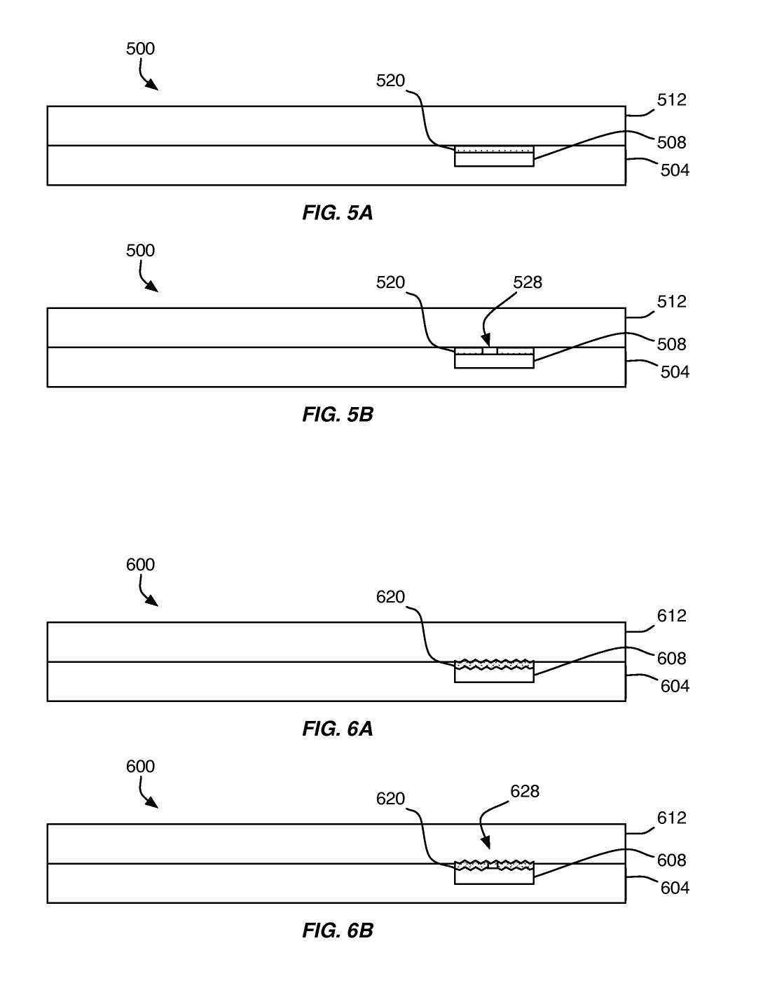

With reference now to FIGS. 5A and 5B, an example of a credential 500 is shown where the credential 500 exhibits both a thin-film metal layer 520 and photoreactive layer 508 that are incorporated on or in a substrate 504 rather than as part of a separate security element. The substrate 504 may be similar or identical to any previously-discussed substrate except that both the photoreactive layer 508 and thin-film metal layer 520 are incorporated on or in one of the major surfaces of the substrate 504. As a protective measure, the major surface of the substrate 504 comprising the photoreactive layer 508 and thin-film metal layer 520 may comprise a transparent layer 512 located in proximity thereto. More specifically, the transparent layer 512 may be provided to protect the thin-film metal layer 520 and photoreactive layer 508. The photoreactive layer 508, thin-film metal layer 520, and transparent layer 512 may be similar or identical to any previously-discussed photoreactive layer, thin-film metal layer, and transparent layer, respectively.

As depicted, the photoreactive layer 508 and thin-film metal layer 520 may be provided in a recess or cavity established on a major surface of the substrate 504. Alternatively, since these layers may be maintained at a relatively small thickness, it may be possible to provide one or both of these layers on the major plane of the major surface of the substrate 504 (e.g., not within a cavity or recess). After these two layers have been established on the major surface of the substrate 504, the transparent layer 512 may be applied to the substrate 504, the thin-film metal layer 520 may be at least partially ablated to reveal the underlying photoreactive layer 508, or a combination of the two steps may be performed. Specifically, an ablated portion 528 may be established in the thin-film metal layer 520 and then the transparent layer 512 may be provided over the substrate 504. Alternatively, the transparent layer 512 may be provided over the substrate 504 and then the ablated portion 528 may be created.

FIGS. 6A and 6B depict yet another example credential 600 in accordance with embodiments of the present disclosure. The credential 600 is similar to credential 500 in that credential 600 comprises a substrate 604 with a photoreactive layer 608 and thin-film metal layer 620 on, in, or proximate to a major surface of the substrate 604. The credential 600 also comprises a transparent layer 612 that substantially protects the thin-film metal layer 620 and photoreactive layer 608. The substrate 604, photoreactive layer 608, thin-film metal layer 620, and protective layer 612 may be similar or identical to any previously-discussed substrate, photoreactive layer, thin-film metal layer, and protective layer, respectively.

One difference between credential 600 and credential 500, however, is that credential 600 comprises at least one holographic feature. In some embodiments, the holographic feature(s) is incorporated into the transparent layer 612 via an embossing process and/or a photopolymerization process. The credential 600 may also have an ablated portion 628 that extends completely through the thin-film metal layer 620, thereby revealing at least a portion of the underlying photoreactive layer 608. In some embodiments, the underlying photoreactive layer 608 may also be partially ablated, depending upon the accuracy of the ablation process used on the thin-film metal layer 620.

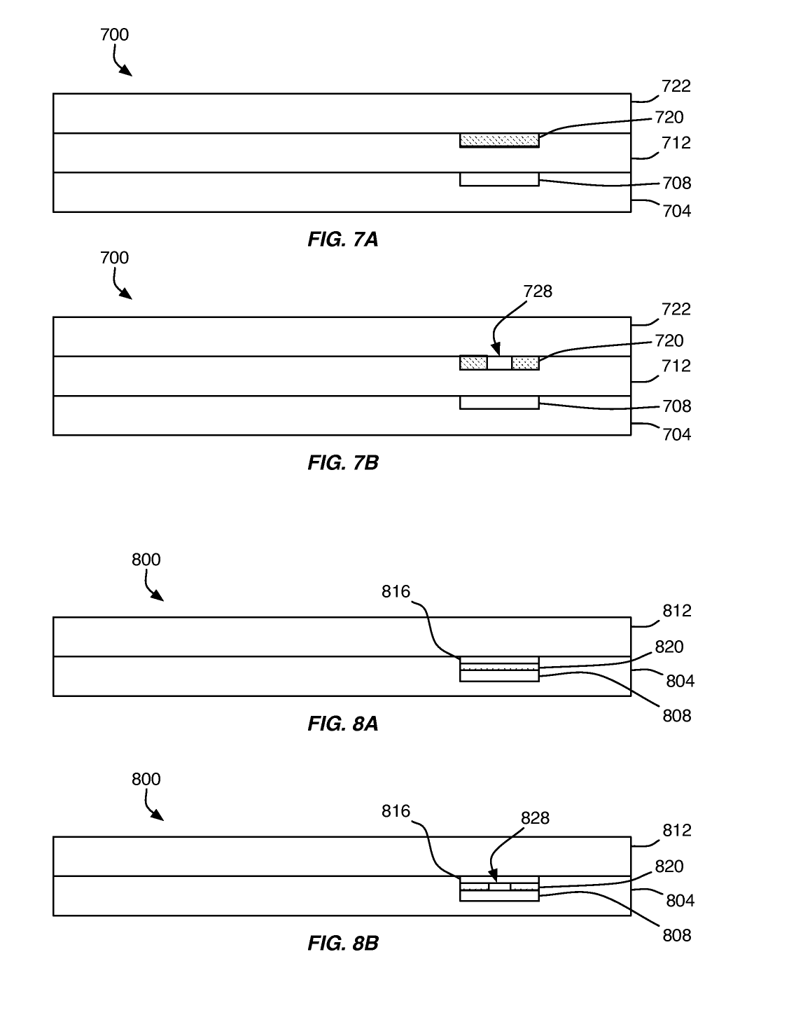

FIGS. 7A and 7B depict another example of a credential 700 in accordance with embodiments of the present disclosure. The credential 700 comprises a substrate 704, a first transparent layer 712, and a second transparent layer 722. The construction of the substrate 704 and transparent layers 712, 722 may be similar or identical to any previously-described substrate and transparent layer, respectively.

The substrate 704 of credential 700 comprises a photoreactive layer 708 on or in one of its major surfaces while the first transparent layer 712 comprises a thin-film metal layer 720 on or in one of its major surfaces. The photoreactive layer 708 and thin-film metal layer 720 may be similar or identical to any previously-described photoreactive layer and thin-film metal layer, respectively.

In the depicted example, the substrate 704 comprises a first major surface and an opposing second major surface. The photoreactive layer 708 is established on or in the first major surface of the substrate 704. The first transparent layer 712 also comprises a first major surface and an opposing second major surface. The second major surface of the first transparent layer 712 is proximate to or abuts the first major surface of the substrate 704. The first major surface of the first transparent layer 712 comprises the thin-film metal layer 720 thereon or therein. It should be appreciated, however, that the thin-film metal layer 720 may be established on the underside of the first transparent layer 712 (e.g., on or in the second major surface of the first transparent layer 712).

The second transparent layer 722 comprises a first major surface and an opposing second major, where the second major surface substantially abuts or is proximate to the first major surface of the first transparent layer 712. In some embodiments, the first transparent layer 712 and second transparent layer 722 are constructed of similar materials while in other embodiments the transparent layers 712, 722 are constructed of different materials.

As shown in FIG. 7B, when an ablated portion 728 is created in the thin-film metal layer 720, at least some of the photoreactive layer 708 becomes visible to a viewer looking at the first major surface of the second transparent layer 722. The ablated portion 728 may be created before or after the first transparent layer 712 is attached to the substrate 704 and/or before or after the second transparent layer 722 is attached to the first transparent layer 712. Furthermore, both transparent layers 712, 722 may be laminated to the substrate 704 in a single lamination step or they may be laminated in separate lamination steps and the ablated portion 728 may be created before or after any such lamination step.

FIGS. 8A and 8B show another example of a credential 800 in accordance with embodiments of the present disclosure. The credential 800 comprises a laminate incorporating a label or hot stamp with both a thin-film metal layer and a photoreactive layer. More specifically, credential 800 comprises a substrate 804 with a cavity or recess established on a major surface thereof. The credential 800 further comprises a transparent layer 812 with a security element attached thereto—where the security element includes a photoreactive layer 808, a thin-film metal layer 820, and an adhesive layer 816, which may be similar or identical to any previously-discussed substrate, transparent layer, photoreactive layer, thin-film metal layer, and adhesive layer, respectively. It should be appreciated that if the security element incorporated on the transparent layer 812 is sufficiently thin, the need for a receiving cavity or recess on the substrate 804 may be obviated.

In this particular embodiment, the adhesive layer 816 connects the thin-film metal layer 820 and/or photoreactive layer 808 to the transparent layer 812. Thus, the thin-film metal layer 820 may be deposited on the photoreactive layer 808 and then the adhesive layer 816 may be applied to the thin-film metal layer 820 so that the security element can be connected to the transparent layer 812.

As shown in FIG. 8B, an ablated portion 828 can be created in the thin-film metal layer 820 to at least partially reveal the underlying photoreactive layer 808. In some embodiments, the ablated portion 828 is created prior to securing the security element to the transparent layer 812. In some embodiments, the ablated portion 828 is created after the security element has been attached to the transparent layer 8128. Moreover, the ablated portion 828 may be created before or after the transparent layer 812 is laminated to the substrate 804.

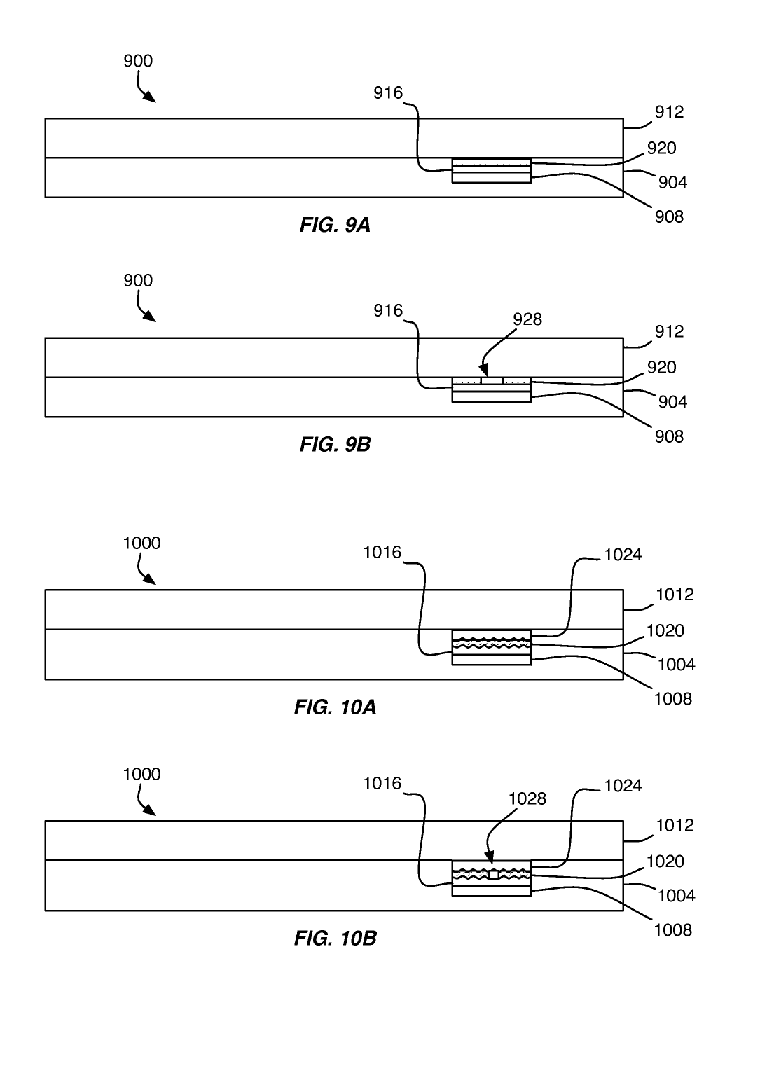

FIGS. 9A and 9B show yet another credential 900 that is similar to credential 800 except that the relative position of the thin-film metal layer and adhesive layer are switched. The credential 900 comprises a laminate with a thin-film metal layer hot-stamped onto a substrate 904 having a photoreactive layer 908. Specifically, credential 900 is shown to include a substrate 904, a transparent layer 912, a photoreactive layer 908, an adhesive layer 916, and a thin-film metal layer 920.

As with credential 800, the credential 900 may have one or more ablated portions 928 that are created in the thin-film metal layer 920 to reveal the underlying photoreactive layer 908. The ablated portions 928 can be created before or after the thin-film metal layer 920 is positioned relative to the substrate 904.

FIGS. 10A and 10B depict another credential 1000 in accordance with embodiments of the present disclosure. The credential 1000 includes a laminate (transparent layer 1012) with a label or patch (e.g., a security element) containing a holographic feature applied to a substrate 1004 with a photoreactive layer 1008. More specifically, the credential 1000 comprises a substrate 1004 with an overlying transparent layer 1012, which may be similar or identical to any previously-described substrate and transparent layer, respectively.

The substrate 1004 may comprise a photoreactive layer 1008 proximate to one of its major surfaces. A label or patch in the form of a security element may be provided between the photoreactive layer 1008 and transparent layer 1012. In some embodiments, the security element includes an adhesive layer 1016, a thin-film metal layer 1020, and a polymer layer 1024. In some embodiments, the polymer layer 1024 is embossed to create a holographic feature in the security element. The photoreactive layer 1008, adhesive layer 1016, and thin-film metal layer 1020 may be similar or identical to any previously-described photoreactive layer, adhesive layer, and thin-film metal layer, respectively.

In some embodiments, the polymer layer 1024 comprises any type of known plastic or combination of plastics. The polymer layer 1024 may be transparent or translucent such that when an ablated portion 1028 is established in the thin-film metal layer 1020 at least some of the photoreactive layer 1008 is visible through the ablated portion 1028. It should be appreciated that the ablated portion 1028 can be established before or after the thin-film metal layer 1020 is sandwiched between the substrate 1004 and transparent layer 1012. Furthermore, it may be possible to have the ablated portion 1028 substantially confined to the thin-film metal layer 1020 (e.g., the polymer layer 1024 may remain unablated).

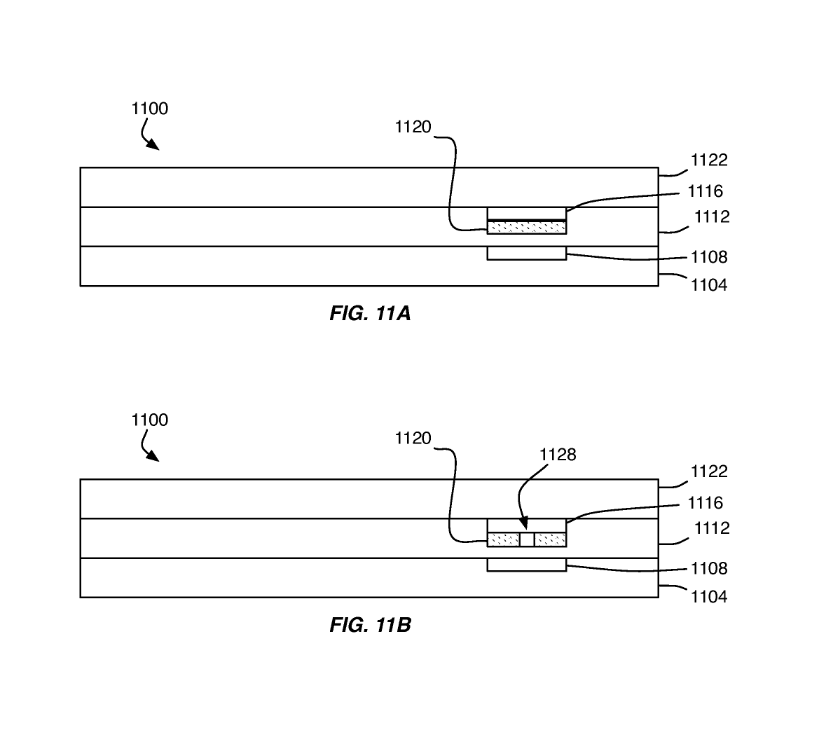

FIGS. 11A and 11B depict still another example of a credential 1100 in accordance with embodiments of the present disclosure. The credential 1100 may be similar to credential 700 in that it comprises a substrate 1104 and two transparent layers 1112, 1122. Credential 1100, however, comprises a laminate with a thin-film metal layer 1120 incorporated in a patch (e.g., security element) that is then applied to a second transparent layer 1122 via an adhesive layer 1116 and then both transparent layers 1112, 1122 are applied to the substrate 1104, which includes a photoreactive layer 1108. The substrate 1104, transparent layers 1112, 1122, photoreactive layer 1108, thin-film metal layer 1120, and adhesive layer 1116 may be similar or identical to any previously-discussed substrate, transparent layer, photoreactive layer, thin-film metal layer, and adhesive layer, respectively.

FIG. 11B shows that an ablated portions 1128 can be created in the thin-film metal layer 1120 to reveal at least some of the underlying photoreactive layer 1108. In some embodiments, the ablated portion 1128 may be created before or after the transparent layers 1112, 1122 are applied to the substrate 1104. Furthermore, the adhesive layer 1116 may or may not be ablated.

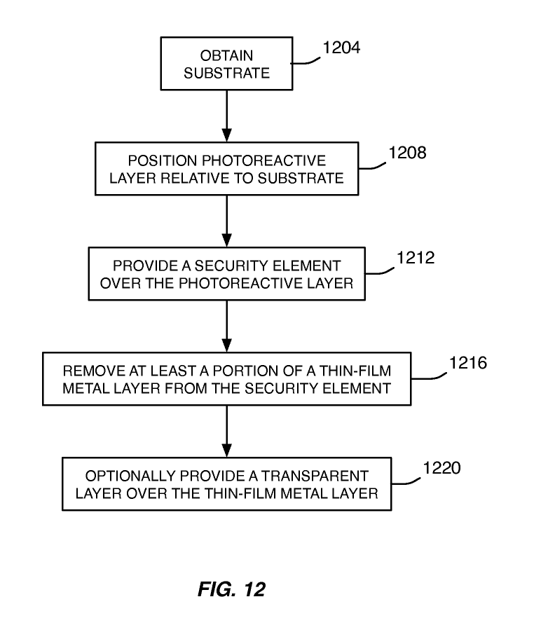

FIG. 12 is a flow chart depicting a method of manufacturing a credential in accordance with embodiments of the present disclosure. It should be appreciated that the depicted method may be used to create any of the credentials described herein or any credential comprising a combination of credential features described herein. Accordingly, although FIG. 12 shows certain steps of the process as being performed in a particular order, it should be appreciated that the order of steps may be altered depending upon the type and nature of credential being produced.

Initially, a substrate is obtained (step 1204) and at least one photoreactive layer is positioned relative to the substrate (step 1208). In some embodiments, the photoreactive layer may be incorporated in the substrate or on the substrate while in other embodiments, the photoreactive layer may be provided in an external security element (e.g., patch, label, stamp, foil, etc.) that can be applied to the substrate.

Thereafter, a security element or laminate layer is provided over the photoreactive layer (step 1212). Of course, step 1212 may be performed before, concurrent with, or after step 1204 and/or step 1208.

At least a portion of the thin-film metal layer may be removed to reveal at least some of the underlying photoreactive layer (step 1216). In some embodiments, the thin-film metal layer may be ablated with a low-power laser. The thin-film metal layer may be ablated before or after it is provided over the photoreactive layer.

An optional step may involve providing one or more transparent layers over the thin-film metal layer thereby sandwiching the thin-film metal layer between the transparent layer and the photoreactive layer (step 1220). As discussed above, the security element incorporating the thin-film metal layer may be provided as part of the transparent layer or the thin-film metal layer may be provided on or in the substrate.

To reiterate, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged without departing from the scope of the present disclosure. A process is terminated when its operations are completed, but could have additional steps not included in the figure.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of creating a security feature for a document, the method comprising:
providing a security element over a substrate, the security element comprising a thin-film metal layer; and
removing at least some portions of the thin-film metal layer to reveal an underlying photoreactive layer, the underlying photoreactive layer being established in at least one of the security element and the substrate.

2. The method of claim 1, wherein the thin-film metal layer comprises a melting point that is less than or equal to about 500 degrees Centigrade.

3. The method of claim 1, wherein the thin-film metal layer comprises tin.

4. The method of claim 1, wherein the thin-film metal layer is between about 250 and 1000 Å.

5. The method of claim 1, wherein the photoreactive layer comprises at least one of a UV and IR visible layer.

6. The method of claim 1, wherein removing comprises ablating the thin-film metal layer with a low-power laser.

7. The method of claim 1, wherein the security element further comprises at least one of a stamp and label having at least one adhesive layer.

8. The method of claim 7, wherein the at least one adhesive layer is positioned between the thin-film metal layer and the underlying photoreactive layer.

9. The method of claim 1, wherein the underlying photoreactive layer is established in the substrate.

10. The method of claim 1, wherein the underlying photoreactive layer is established in the security element.

11. The method of claim 1, wherein at least one of the thin-film metal layer and the photoreactive layer are provided in a laminate.

12. The method of claim 1, wherein the security element further comprises a holographic feature.

13. A credential manufactured according to the method of claim 1.

14. A paper document manufactured according to the method of claim 1.

15. A document having at least one security feature integrated therein, the document comprising:
a substrate layer having a first surface and a second opposing surface;
a thin-film metal layer positioned in proximity to the first surface of the substrate layer; and
a photoreactive layer positioned between the first surface of the substrate layer and the thin-film metal layer such that removed portions of the thin-film metal layer reveal at least a portion of the photoreactive layer.
